(19) United States
(12) Patent Application Publication
(10) Pub. No.: US 2023/0153530 A1
(43) Pub. Date: May 18, 2023

(54) Real Time Transcript Summarisation

(71) Applicant: Babylon Partners Limited, London (GB)

(72) Inventors: Sasho SAVKOV, London (GB); Francesco MORAMARCO, London (GB); Alexander PAPADOPOULOS-KORFIATIS, London (GB)

(21) Appl. No.: 17/524,999

(22) Filed: Nov. 12, 2021

(51) Int. Cl. G06F 40/284; G06F 40/131; G06F 40/166; G06N 3/04

(52) U.S. Cl. CPC G06F 40/284; G06F 40/131; G06F 40/166; G06N 3/0454

(57) ABSTRACT

According to an aspect there is provided a computer-implemented method for determining summaries of text over multiple batches of text. The method comprises: for each of a plurality of batches of text, each batch comprising text for addition to a cumulative document: adding the batch of text to the cumulative document to produce an updated cumulative document; encoding the updated cumulative document using an encoder neural network to obtain one or more encoder hidden states; inputting the one or more encoder hidden states and a cumulative summary that summarises each preceding batch of text into a decoder neural network to generate a summary for the batch of text; and updating the cumulative summary by adding the summary to the cumulative summary. The method further comprises outputting each summary.

### TECHNICAL FIELD

The present disclosure relates to methods and systems for determining summaries of text. In particular, but without limitation, this disclosure relates to computer implemented methods and systems for summarising transcripts of speech in real time. This is particularly useful for summarising speech in real time, for instance, in producing summaries of medical consultations. By generating the summary in real time, the user can review and add additional content or correct any errors as they appear.

### BACKGROUND

This specification relates to neural network systems for producing summaries of text. The internet and big data has meant that the amount of information available to information has increased greatly. Text summaries can be very useful by reducing the amount of information that needs to be reviewed whilst providing the most important points. Neural networks can be used to generate summaries of text automatically to avoid the need for reviewers to manually read information and compile summaries.

### SUMMARY

According to an embodiment, a cumulative summary may be iteratively generated as different batches of text are received, wherein each iteration of the cumulative summary is generated by encoding all of the previously received text using an encoder to generate one or more encoder hidden states and using these one or more encoder hidden states, as well as the previous cumulative summary, to condition the generation of the next section of the summary for addition to the cumulative summary. This allows a summary to be generated in real-time as batches of text are received.

By feeding the previous summary into the decoder, the decoder is able to build on the previous summary without having to regenerate the earlier words in the summary. Furthermore, conditioning the decoder on the previous summary allows the decoder to make use of the information in the previous summary, helping to avoid repetition. The method is therefore able to more efficiently determine summaries in real time based on batches of received words.

In addition to the above, by conditioning the decoder on the previous summary, the summary can be generated in batches and fed to a user for review in real time. For each batch of text, the conditioned decoder generates a new section of the summary that follows on from the previously generated summary and can be concatenated to the end of the previous summary. In contrast, if the decoder were not conditioned in this manner, then a whole new summary, summarising the whole of the document so far, would be generated each time. In this case, earlier sections of the summary may differ between different iterations of the summary. This means that the user cannot consistently or accurately review or edit the summary in real time, as earlier sections of the summary may change over time.

Furthermore, once the final batch of words has been received, the method only needs to process this final batch of words. As the time taken to generate a summary is directly proportional to the amount of words being generated, the final summary (the summary over all batches) can be provided to the user more quickly, as only the final batch has to be processed at this point, rather than the whole document.

According to an aspect there is provided a computer-implemented method for determining summaries of text over multiple batches of text. The method comprises: for each of a plurality of batches of text, each batch comprising text for addition to a cumulative document: adding the batch of text to the cumulative document to produce an updated cumulative document; encoding the updated cumulative document using an encoder neural network to obtain one or more encoder hidden states; inputting the one or more encoder hidden states and a cumulative summary that summarises each preceding batch of text into a decoder neural network to generate a summary for the batch of text; and updating the cumulative summary by adding the summary to the cumulative summary. The method further comprises outputting each summary.

The batches may be obtained separately over time and each summary may be generated in response to the obtaining of the corresponding batch. That is, the summaries may be generated in real time as the batches are obtained. Obtaining may include receiving the batches from an external source or generating the batches (such as generating transcripts of different sections of a conversation from a recording of the different sections). Each batch may be immediately processed to determine a summary in response to the batch being obtained.

The method may further comprise generating each batch by receiving a sequence of text and grouping the sequence of text into batches. That is, a sequence of text may be received (e.g. as a stream of text, such as word by word), and then may be grouped into batches (for instance, when a predefined condition has been met, such as a predefined number of words within a batch). Each batch may be generated as soon as the predefined condition is met. For instance, each batch may comprise: a predetermined number of words; a predetermined number of sentences; a predetermined number of statements; or a predetermined number of phrases. In addition, or alternatively, the sequence of text may be a transcript of a conversation between multiple people and each batch may relate to a predetermined number of turns in conversation. A turn in conversation may be a contiguous series of one or more words, statements or phrases by a single individual before another individual speaks.

Outputting each summary may comprise one or more of: outputting each summary separately; outputting each cumulative summary separately; and outputting each summary as part of a final cumulative summary comprising every summary for every batch of the plurality of batches. That is, summaries may be output separately or cumulatively and a summary and/or cumulative summary may might be output at an end point (e.g. after all summaries have been generated) or as the summary and/or cumulative summary is generated.

For a first batch of the plurality of batches, inputting the one or more encoder hidden states and a cumulative summary that summarises each preceding batch of text into a decoder neural network may comprise inputting the context vector and a start of sequence token. That is, when generating the summary for a first batch of text, the cumulative summary that summarises each preceding batch of text may consist only of a start of sequence token.

For a first batch of the plurality of batches, adding the batch of text to the cumulative document to produce an updated cumulative document may comprise setting the cumulative document to consist only of the first batch.

According to an embodiment, each generated summary ends with an end of sequence token, and the end of sequence token is removed from the cumulative summary before the cumulative summary is input into the decoder. An end of sequence token may be an end of sentence token.

According to an embodiment, each generated summary ends with an end of sequence token, and the end of sequence token is removed from the cumulative summary before the cumulative summary is updated.

According to a further aspect of there is provided a system for determining summaries of text over multiple batches of text. The system comprises one or more processors configured to: for each of a plurality of batches of text, each batch comprising text for addition to a cumulative document: add the batch of text to the cumulative document to produce an updated cumulative document; encode the updated cumulative document using an encoder neural network to obtain one or more encoder hidden states; input the one or more encoder hidden states and a cumulative summary that summarises each preceding batch of text into a decoder neural network to generate a summary for the batch of text; and update the cumulative summary by adding the summary to the cumulative summary. The one or more processors are further configured to output each summary.

According to a further aspect there is provided a non-transitory computer readable medium comprising computer executable instructions that, when executed by one or more processors, cause the one or more processors to perform a method comprising, for each of a plurality of batches of text, each batch comprising text for addition to a cumulative document adding the batch of text to the cumulative document to produce an updated cumulative document; encoding the updated cumulative document using an encoder neural network to obtain one or more encoder hidden states; inputting the one or more encoder hidden states and a cumulative summary that summarises each preceding batch of text into a decoder neural network to generate a summary for the batch of text; and updating the cumulative summary by adding the summary to the cumulative summary. The computer executable instructions, when executed by the one or more processors, also cause the one or more processors to output each summary.

### BRIEF DESCRIPTION OF THE DRAWINGS

Arrangements of the present invention will be understood and appreciated more fully from the following detailed description, made by way of example only and taken in conjunction with drawings in which:

FIG. 1 shows a block diagram of a communication system including automatic transcription summarisation;

FIG. 2 shows an encoder-decoder structure for summarisation;

FIG. 3 shows an encoder-decoder structure for real-time summarisation in accordance with an embodiment;

FIG. 4 shows an example of an exchange in conversation input into a summarisation system according to an embodiment;

FIG. 5 shows a continuation in the conversation of FIG. 4. A second exchange follows the first exchange;

FIG. 6 shows a method of generating an updated summary of text according to an embodiment; and

FIG. 7 shows a computing device 200 using which the embodiments described herein may be implemented.

### DETAILED DESCRIPTION

It is an object of the present disclosure to improve on the prior art. In particular, the present disclosure provides a real time summarisation system that is able to accurately summarise text that is provided in batches over time. This differs from other systems that require the full text to be provided before summarisation begins. By producing summaries from batches of text, the system is able to provide summaries for review as the batches are received, allowing the summaries to be reviewed earlier, for instance, to correct any errors or to add to the summaries.

The present disclosure is particularly relevant to the generation of summaries of transcripts of speech (although, is not limited to this application). For instance, medical notes from a consultation may be generated in real time during the consultation. This allows the doctor to review the notes for accuracy in real time. By allowing the notes to be reviewed in real time, the doctor is able to more effectively correct and annotate the notes whilst the information of discussed in the consultation is fresh in their mind.

In particular, the present disclosure addresses one or more technical problems tied to computer technology and arising in the realm of computer networks, in particular the technical problems of memory usage, and processing speed. Whilst it is possible to generate independent summaries based on batches of text, the present methodology bases the generation of each summary on the previous summaries generated so far and based on the previous batches of text received so far. This allows the summarisation system to leverage information in the previous batches of text and summaries to generate more effective summaries going forwards. This also reduces or removes the need for post processing steps that might be required to delete repetition within the summaries or the need for adjustment to the decoder architecture to prevent such repetition being generated. This can occur where summaries for each batch are generated independently of each other.

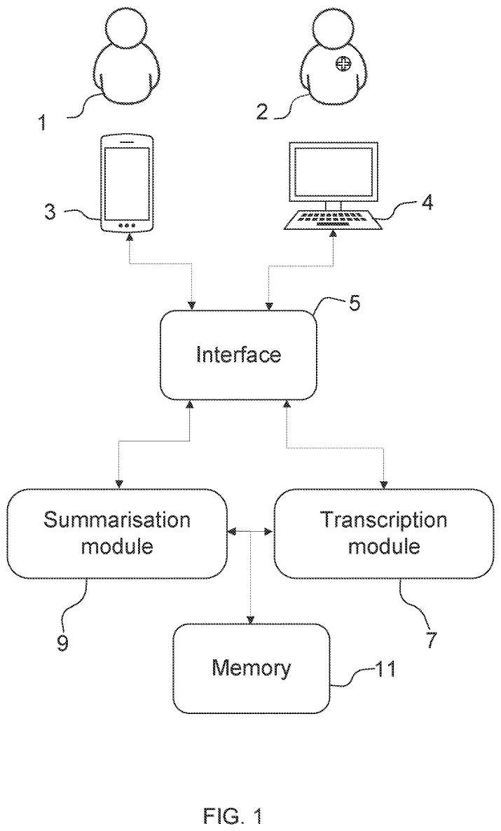

FIG. 1 shows a block diagram of a communication system including automatic transcription summarisation. A first user 1 (e.g. a patient) communicates to the communication system via a mobile phone 3. However, any device could be used which is capable of communicating information over a computer network, for example, a laptop, tablet computer, information point, fixed computer, voice assistant, etc.

The mobile phone 3 is configured to communicate with an interface 5 of the communication system (e.g. via a network connection). The interface 5 facilitates communication with a second user 2 (in this case, a doctor) via a computer 4. However, any device could be used which is capable of communicating information over a computer network, for example, a laptop, tablet computer, information point, fixed computer, voice assistant, etc.

The communication system is configured to establish a communication channel between the mobile phone 3 and the computer 4. This communication channel may convey audio and/or video information between the mobile phone 3 and the computer 3. For instance, a video feed of the first user 1 may be sent to the computer 4 via the interface 5 and a video feed of the second user 2 may be sent to the mobile phone 3 via the interface 5. The communication channel may be managed by the interface 5. The communication channel may convey speech information (e.g. an audio feed of speech) between the users 1, 2 to facilitate a remote conversation.

The communication system may transcribe any speech within the conversation (taken from the communication channel) and provide a summary of the conversation. Accordingly, the interface 5 may pass audio information to a transcription module 7 configured to generate a transcription of the speech. A transcription may be a set of words representing the words spoken in the audio information. The transcription module may utilise any known audio to text transcription method.

The transcription module 7 is configured to send a copy of the transcription a summarisation module 9 for the generation of a summary of the transcription.

The summarisation module 9 is configured to generate a summary of the transcription, e.g. a set of words that represents the most important information within the transcription in a shorter or more compressed form. As described herein, the summarisation module 9 is configured to generate a summary of the conversation between the first user 1 and second user 2 in real time without having to wait for a full transcription of the conversation (i.e. without having to wait until the end of the conversation). As more audio data is received by the interface 5 representing further speech within the conversation, the transcription module 7 is configured to produce a further transcription for addition to the previous transcription. The further transcription can be passed to the summarisation module 9 for processing, which can then add additional words to the summary, if needed. In some circumstances, additional words may not need addition to the summary, for instance, where the further transcription does not provide any important additional information.

The summarization module 9 is configured to generate each summary based on a batch of text. The transcription may be provided to the summarisation model 9 in real time. That is, a stream of text (a continuous sequence of text) may be provided to the summarisation module 9 as it is generated. The summarisation module 9 may then group (or chunk) the text into batches for summarisation. Alternatively, the text may chunked by the transcription module 7 and sent to the summarisation module 9 be sent in batches.

The batches of words may be divided through various methods. In one embodiment, each batch relates to a corresponding sentence or phrase. Alternatively, each batch may represent a turn in conversation (for instance, words spoken by one individual before another individual speaks) or an exchange in conversation (e.g. a pair of turns of conversation). Alternatively, each batch may represent a predefined number of words.

For instance, each batch may represent an exchange in conversation. This may be comprise two parts, a first part relating to words spoken by a first individual, and a second part relating to words spoken by a second individual. The second part may immediately follow the first part.

A summary may be generated as soon as a new batch has been obtained. For instance, a stream of text may be received. As soon as the text forms a new batch (e.g. as soon as the system determines the text received since the previous batch can be grouped into a batch), this batch can be processed to produce a summary. For instance, each batch may relate to a linguistic unit or group, such as a sentence, paragraph, turn in conversation, exchange in conversation, or simply a predefined number of words. The stream of text may be monitored until a new linguistic unit or group have been received, and then the new linguistic unit or group may be grouped into a batch and summarised.

The summarisation module 9 may be configured to send the summary, in real time as it is generated and updated, to one or both of the first user 1 and the second user 2 (e.g. the doctor) via the interface 5. Similarly, the transcription module 7 may be configured to send the transcription, as it is generated and updated, to one or both of the first user 1 and the second user 2 (e.g. the doctor) via the interface 5. The summary and/or transcription may be displayed to the respective user, and the user may make alterations or corrections as the transcription and/or summary is generated. In addition, the summary and/or transcription may be stored in memory 11 for access by one or both of the users 1, 2 after the conversation has ended.

In particular, in a remote consultation between a patient (the first user 1) and a doctor (the second user 2) the summary and/or transcription may be provided to the doctor in real time. This allows the doctor to annotate the summary and/or transcription and correct any errors in the summary and/or transcription in real time. The doctor may choose to make use of the summary as part of the doctor's notes following the consultation. By allowing the doctor to correct and/or add to the summary as it is generated, the doctor is able to check the accuracy and generate notes in real time as the conversation progresses, allowing any changes to be made when the conversation is fresh in the doctor's mind. This saves the doctor time, and helps ensure that the summary is as accurate as possible, and no information is missed. If the summary were only provided at the end of the consultation, there is an increased risk that missing information may not be spotted, as more time has passed since the information was discussed. Furthermore, the process of reviewing the summary is more difficult, as a large amount of information needs to be reviewed in one sitting.

The present disclosure provides a method for real time text summarisation that allows summaries of text to be generated in real time and updated as new text is added. Whilst this is particularly applicable to transcriptions of speech, it can be applied to any form of text where new text is added to previous text (e.g. any type of text being received in portions).

In addition, whilst the embodiment of FIG. 1 shows a summarisation system for a remote consultation, the methods described herein may be equally applied to transcriptions of only one person is speaking, or where multiple people are speaking in the same location (for instance, in person consultations that are locally recorded). In this case, the speech data is received from only a single source (e.g. recording equipment in the location). Having said this, it is more easy to differentiate different speakers when they each have their own respective microphones and, in particular, where they are not in the same location.

The methods described herein may be implemented generally using computing systems that include neural networks. A neural network (or artificial neural network) is a machine learning model that employs layers of connected units, or nodes, which are used to calculate a predicted output based on an input. Multiple layers may be utilised, with intervening layers relating to hidden units describing hidden parameters. The output of each layer is passed on to the next layer in the network until the final layer calculates the final output of the network. The performance of each layer is characterised by a set of parameters that describe the calculations performed by each layer. These dictate the activation of each node. The output of each node is a non-linear function of the sum of its inputs. Each layer generates a corresponding output based on the input to the layer and the parameters for the layer.

Automatic Text Summarisation

Automatic summarisation is the task of summarising an input document into a shorter summary with the use of a computer system. The summary need not include words selected from the initial input, but instead can be a paraphrasing of the important information within the input document, potentially using vocabulary absent from the input document.

A summarisation system can include a sequence to sequence deep learning model made up of two main components: an encoder, which takes in the input document as a sequence of tokens; and the decoder, which produces the output summary one token at a time.

As discussed herein, the methodology deals with “tokens”. Each token may be a unit of text, such as a word. Each word may be any string of characters. Generally, this is a word from a dictionary, but this need not be the case. For instance, a start of sequence token <SOS> (otherwise known as a start of sentence token) may be used to indicate the start of a string of generated text (e.g. the start of a summary), and an end of sequence token <EOS> (otherwise known as an end of sentence token) may be used to indicate the end of a string of generated text (e.g. the end of a summary).

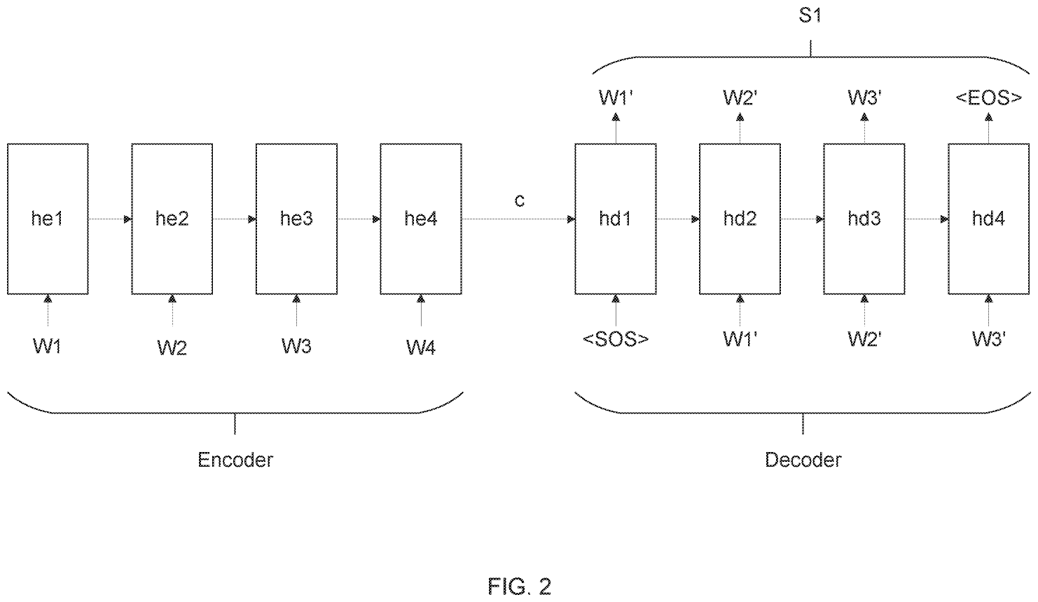

FIG. 2 shows an encoder-decoder structure for summarisation.

The encoder receives a sequence of words, in this case, words W1, W2, W3 and W4. The encoder generates a context vector c comprising one or more encoder hidden states based on the input words and passes the context vector c to a decoder. The decoder receives a start of sequence token <SOS> and generates a sequence of summary words S1 based on (conditioned on) the context vector c.

Both the encoder and decoder are recurrent neural networks (RNNs). The encoder generates encoded words he1-he4 over a number of time steps (in this case, four time steps). At each time step, the encoding is conditioned on the encoded word from the previous time step. FIG. 2 shows flow of data over time, with time increasing from left to right.

The first word W1 is input into the encoder to produce a respective encoded word he1 (a first encoder hidden state). This encoded word he1 is fed back into the encoder for the next time step. At the next time step, the encoder receives the next input word W2 and the previous encoded word he1 and generates the next encoded word he2 (a second encoder hidden state). In this way, an encoded word (encoder hidden state) is generated for each word in the input sentence, with each encoded word being dependent on the preceding encoded word. After the last word W4 is encoded, the final encoding (the final encoder hidden state) is then passed as a context vector c to the decoder. The context vector represents an encoding of the information within the input sentence.

The decoder receives the context vector and is configured to determine a summary S1 comprising a set of words (usually of reduced length relative to the input sentence) that summarises the information conveyed in the context vector. A similar recurrent architecture is used; however, in this case, the decoder receives the context vector and a start of sequence token <SOS>. The output of the decoder at the first time step is a first decoded word W1′ and a hidden state hd1 (a first decoder hidden state). That is, the decoder generates the start of sequence token <SOS> conditioned on the context vector to produce the first decoded word W1′ and hidden state hd1. The hidden state hd1 is fed back into the decoder for the next time step. The first decoded word W1′ is also fed back into the decoder, as the input for the next time step. In this way, the decoded word output at each time step is passed to the next time step as an input. This continues until the decoder generates an end of sequence token <EOS>. In the present case, three decoded words are generated by the decoder (W1′, W2′ and W3′) which form the summary S1 of the input sentence (W1, W2, W3 and W4).

The encoder therefore encodes the input sequence of tokens (words) as a context vector. The decoder takes the context vector and generates a target sequence of tokens (decoded words) as a summary. Generally, the summary is a compressed version of the input sequence. Summarisation differs from other natural language transformation methods, such as machine translation, in that the output is a summary that is generally shorter (potentially much shorter) than the input, and which is compressed in a lossy manner, such that key concepts are maintained but extraneous detail is lost. This differs from machine translation in that machine translation tends to aim to be lossless. Furthermore, unlike machine translation, the summary is in the same language as the input sequence.

FIG. 2 shows the encoder encoding each word in sequence. In addition to each word being input to the encoder, additional linguistic features relating to the input word/token may be input with each word, such as parts of speech tags, named-entity tags, and term frequency (TF) or inverse document frequency (IDF) statistics.

Whilst FIG. 2 shows the context vector being passed to the decoder only at the first time step of decoding, the encoder decoder structure can be adapted to include attention at each decoding step over each embedded word (each embedding step). In this case, each embedded word is passed to the decoder which applies attention over the embedded words at each step when generating decoded words.

The methodology of FIG. 2 can be used to process an entire document to produce a summary of the whole document. This is effective when the whole document is initially available (e.g. the whole document is received at one time) but where the tokens (words) are received in batches, such as in real-time transcription of speech, the method has to wait until all tokens have been received in order to produce the summary. This is because the decoder makes use of an encoding of every token in the input (through the context vector) in order to start generating the summary, and the decoder only decodes individual tokens at each step, starting from the <SOS> token. In addition, as the whole document has to be processed, it can take longer to generate the final summary after the full document has been received.

In order to overcome this problem, the architecture of FIG. 2 can be adapted to iteratively generate a summary based on batches of tokens (chunks of a document received over time).

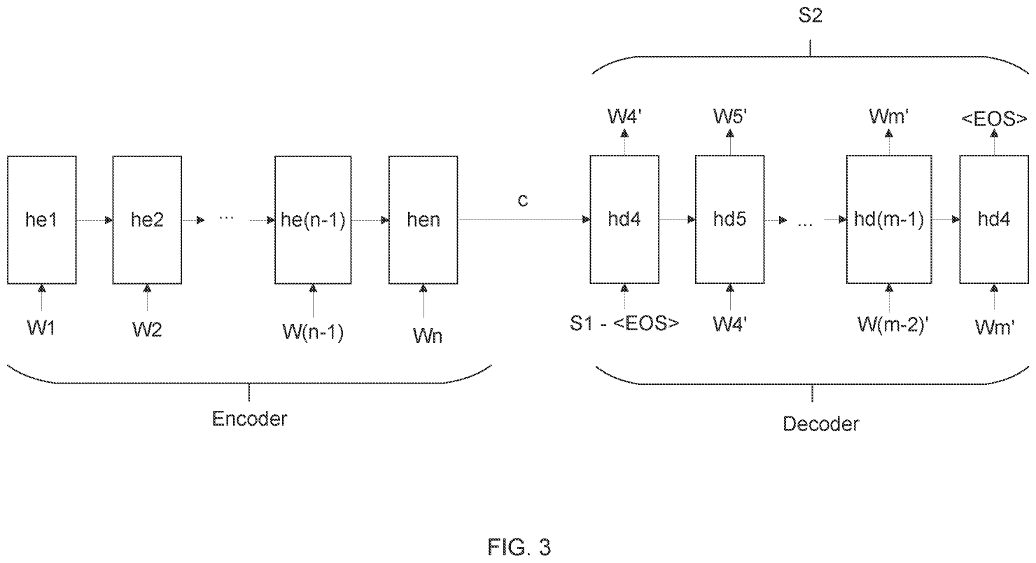

FIG. 3 shows an encoder-decoder structure for real-time summarisation in accordance with an embodiment. The architecture mirrors that of FIG. 2, however, the input to the decoder is adapted. In fact, the method for generating the initial summary from an initial batch of tokens is the same as that of FIG. 2; however, instead of inputting a full document into the encoder, the first batch of tokens received so far is input into the encoder. Nevertheless, the encoder processes this batch of tokens and generates a context vector c including one or more encoder hidden states in a similar manner to the method of FIG. 2. The decoder operates similar to the decoder of FIG. 2, inputting the context vector c and a start of sequence token <SOS> into the decoder at a first time step, and generating a set of decoded words over a number of time steps (iterations) to produce a first summary S1.

How the method differs from that of FIG. 2 in that tokens are processed in batches as they are received. In addition, for batches of tokens after the first batch, the method is adapted so that the decoder is conditioned on the previously generated summaries.

For each batch of tokens after the first batch, the full sequence of tokens received so far is input into the encoder (i.e. all batches so far are input into the encoder). The resulting context vector is fed to the decoder. The decoder, however, instead of receiving a start of sequence token as a first input, receives the previously generated summary (in this case, S1). The end of sequence token <EOS> is removed from the previous summary and the resultant set of tokens is input into the decoder. The decoder then determines the next decoded word in the sequence based on the previous summary (excluding <EOS>) and the context vector c encoded based on the whole received sequence so far.

FIG. 3 shows the processing of a second batch, following a first batch processed as shown in FIG. 2. In this case, the first and second batches combine form a cumulative document comprising n tokens (where n is a positive integer) which are fed into the encoder as discussed above. The previous summary S1 is fed into the decoder at a first time step, which generates a fourth decoded word W4′. This continues until the end of sequence token <EOS> is generated. In this case, m−3 decoded words are output (where m is a positive integer, and is preferably less than n), as the previous summary S1 consisted of 3 words.

The new summary (in this case, S2) can be combined with the previous summary S1 (excluding the <EOS> token from the end of S1) to form an updated summary S′.

By encoding all tokens received so far each time, the context vector is able to encode the information across the whole set of input text, thereby encoding this information more efficiently and allowing the new summary to make use of information from previous batches. By feeding the previous summary into the decoder, the decoder is able to build on the previous summary without having to regenerate the earlier words in the summary.

Furthermore, conditioning the decoder on the previous summary allows the decoder to make use of the information in the previous summary, helping to avoid repetition. The method is therefore able to more efficiently determine summaries in real time based on batches of received words.

In addition to the above, by conditioning the decoder on the previous summary, the summary can be generated in batches and fed to a user for review in real time. For each batch of text, the conditioned decoder generates a new section of the summary that follows on from the previously generated summary and can be concatenated to the end of the previous summary. In contrast, if the decoder were not conditioned in this manner, then a whole new summary, summarising the whole of the document so far, would be generated each time. In this case, earlier sections of the summary may differ between different iterations of the summary. This means that the user cannot consistently or accurately review or edit the summary in real time, as earlier sections of the summary may change over time.

Furthermore, once the final batch of words has been received, the method only needs to process this final batch of words. As the time taken to generate a summary is directly proportional to the amount of words being generated, the final summary (the summary over all batches) can be provided to the user more quickly, as only the final batch has to be processed at this point, rather than the whole document.

It should be noted that the architecture of FIG. 2 and FIG. 3 is but one example for implementing the methodology described herein. For instance, the recurrent neural network architecture may be replaced with a transformer architecture. In this case, rather than the encoder generating encoder hidden states recurrently and then passing only the final encoder hidden state to the decoder at a final time step, a corresponding encoder hidden state may instead be output for each word in the input. These encoder hidden states may be output separately (e.g. as separate vectors) or in a combined form (e.g. a combined context vector or matrix). In this way, the decoder may apply attention over all of the encoder hidden states. The one or more encoder hidden states output by the encoder may be in the form of one or more vectors or matrices (such as a key matrix and/or a value matrix for use with a query matrix generated by the decoder).

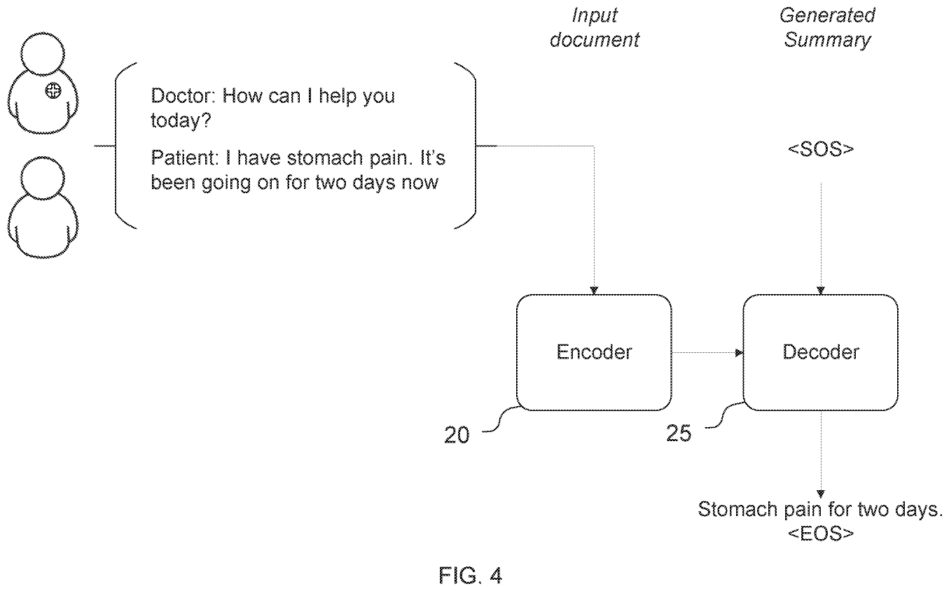

FIG. 4 shows an example of an exchange in conversation input into a summarisation system according to an embodiment. In the present example, a doctor is speaking with a patient. The first exchange includes two statements (or turns in conversation): the first by the doctor and the second by the patient:
Doctor: “How can I help you today?”
Patient: “I have stomach pain. It's been going on for two days now.”

This exchange (this set of two statements by two individuals) is transcribed and input into the encoder 20 as an input document. As discussed above, the encoder encodes the input document and passes the resultant context vector to the decoder 25.

The decoder 25 takes, as an input, the context vector and any preceding summary. In this case, as this is the first exchange in the conversation, no preceding summary exists, so only a start of sequence token “<SOS>” is input as the preceding summary. The decoder 25 decodes the preceding summary, conditioned on the context vector, in order to generate the summary “Stomach pain for two days <EOS>”. The resultant summary is then the concatenation of the preceding summary “<SOS>” and the newly generated summary “Stomach pain for two days <EOS>”. This results in a combined summary for the exchange of “<SOS> Stomach pain for two days <EOS>”.

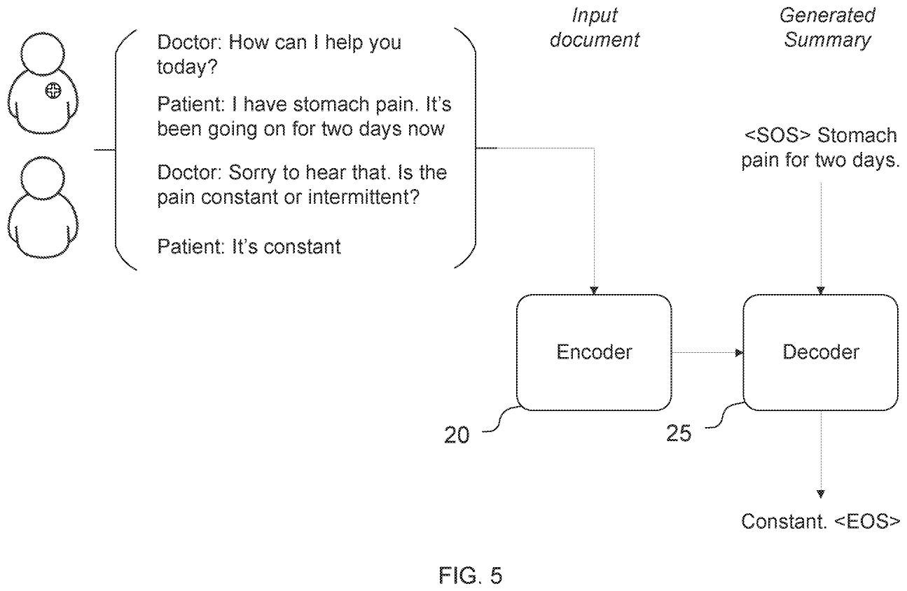

FIG. 5 shows a continuation in the conversation of FIG. 4. A second exchange follows the first exchange. The second exchange includes two statements (or turns in conversation), the first by the doctor and the second by the patient:
Doctor: “Sorry to hear that. Is the pain constant or intermittent?”
Patient: “It's constant”

The second exchange is added (concatenated) to the end of the first exchange to produce an updated input document representing a transcription of the conversation so far. The updated input document is input into the encoder 20. Again, the encoder generates a context vector which is input into the decoder 30. In this case, the decoder receives as an input the combined summary generated so far (with the removal of the <EOS> token from the previous combined summary): “<SOS> stomach pain for two days”. The decoder then decodes the preceding combined summary, conditioned on the context vector, to output a new summary “Constant. <EOS>”. The new summary is added to (concatenated onto) the previous summary (with the <EOS> token removed from the previous summary) to produce an updated combined summary “<SOS> Stomach pain for two days. Constant. <EOS>”.

Accordingly, at each iteration, the full transcription of the conversation so far is input into the encoder 20 and the preceding combined summary is input into the decoder 25 to generate an updated summary. The updated summary is combined with the previous combined summary to produce an updated combined summary.

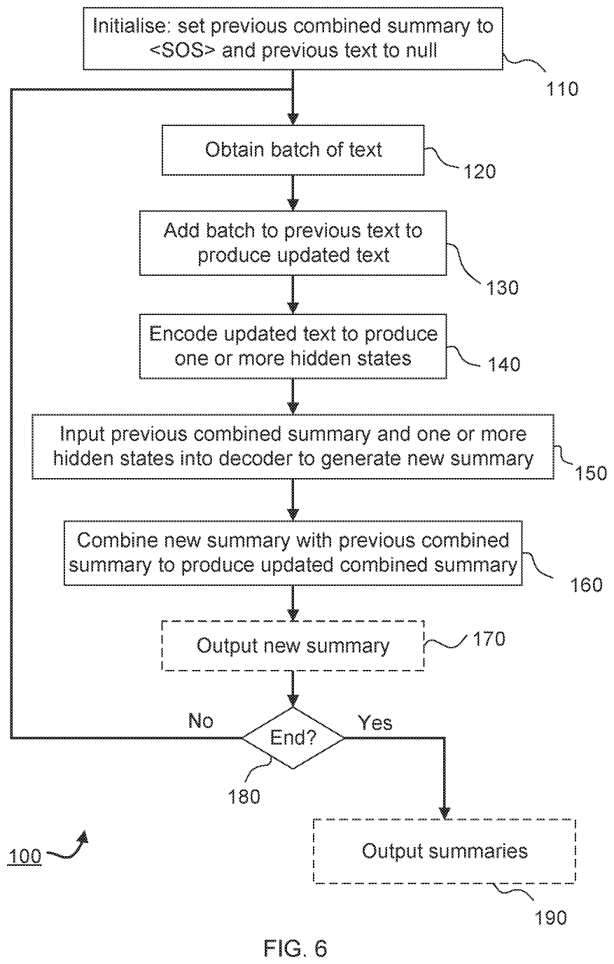

FIG. 6 shows a method 100 of generating an updated summary of text according to an embodiment.

The method operates over a number of iterations. As each step/iteration references values from a previous step/iteration (in particular, the previous summary and previous text), the method starts by initialising the previous combined summary and previous text values. Specifically, the previous combined summary is set to a start of sequence token <SOS> and the previous text is set to null 110. The method then operates over a number of iterations, with each iteration relating to a different batch of text.

For each iteration, the method: obtains a batch of text 120; adds the batch to the previous text to produce updated text 130; encodes the updated text to produce a context vector 140; decodes the previous combined summary, conditioned on the context vector, to produce a new summary 150; and combines the new summary with the previous combined summary to produce an updated combined summary 160.

In step 120, a batch of text is obtained. As discussed above, the batch of text may comprise a set of one or more tokens. The batches all relate to a cumulative document that is formed by combining the batches. The batch may be received, for instance, from a transcription module which is configured to transcribe speech, or may be produced as part of the method from a sequence of text (e.g. a sequence received from a transcription module). Having said this, the method is not limited to operating on transcribed speech, and may be applied to any set of text which is received or grouped in batches (e.g. a feed of batches over time).

In step 130, the batch is added to any previous text (batches) to produce updated text 130. This forms a cumulative document that is built up over time. Each batch is concatenated/appended onto the end of the preceding batch. If no previous text (batches) exist (i.e. in the first iteration), then the updated text comprises just the first received batch (as the previous text is initialised as null, or empty).

In step 140, the updated text (cumulative document) is encoded to produce a context vector 140. This process is shown in FIGS. 2 and 3. As discussed, the encoder may be a recurrent neural network. In this case, each word in the cumulative document is fed into the encoder over a number of time steps. The context vector is output once the final word in the updated text is encoded.

In step 150, the previous combined summary is decoded, conditioned on the context vector, to produce a new summary 150. In other words, the decoder generates a new summary based on the context vector and the combined summary from the previous iteration. If no previous combined summary existed (e.g. this is the first iteration), then the start of sequence token <SOS> is taken as the previous summary (as per the initialization in step 110). The new summary is a summary of the batch for this iteration. Notably, in some embodiments, each summary might contain an end of sequence token, and the decoder may decode over a number of time steps until an end of sequence token is generated. In this case, the end of sequence token may be removed from the previous summary before it is input into the decoder.

In step 160 the new summary is combined with the previous combined summary to produce an updated combined summary. The new summary may be concatenated (appended) to the end of the precious combined summary. Where the previous combined summary includes an end of sequence <EOS> token, this token may be removed from the previous combined summary before the new summary is appended.

In step 180, at the end of each iteration, the method determines whether an end criterion has been satisfied (i.e. whether the last iteration has been completed). If not, then method loops back to step 120 to start another iteration. If the end has been reached, then the method ends, optionally outputting one or more of the summaries 190.

Each new summary may be output 170 during each iteration. This, however, is not essential, as the method may wait until a number (or all) of the batches have been processed before outputting the summaries 190. The summaries may be output separately, or as a combined summary. The combined summary may be a combination of all summaries generated so far, with each summary being concatenated or appended to the end of the preceding summary.

When outputting any summaries, these summaries may be output for storage (e.g. locally stored in memory), may be output for display, and/or may be output to an external device. For instance, as each summary is generated, the combined summary so far may be displayed (either locally or on an external device) for review and/or editing by a user. This allows the summary to be reviewed and/or edited in real time, making it easier to identify any issues or errors in the summaries.

The methods described herein make use of an encoder neural network and a decoder neural network. These neural networks may be trained via supervised learning based on manually generated training summaries (target summaries). During training, the parameters of the neural networks are updated e.g. to increase the likelihood of the neural networks generating the target summaries.

The encoder and decoder need not be trained to generate summaries in batches, as described herein. Instead, the encoder and decoder may be trained on whole documents and summaries of whole documents. Nevertheless, through the adjustments in architecture described herein, such whole-document summary models may be adapted to generate summaries over batches in real time.

Computing Device

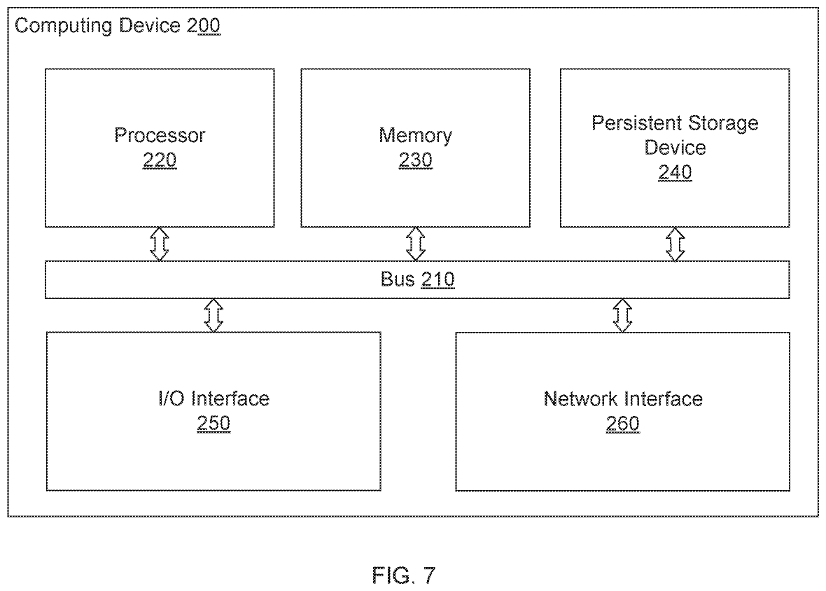

FIG. 7 shows a computing device 200 using which the embodiments described herein may be implemented.

The computing device 200 includes a bus 210, a processor 220, a memory 230, a persistent storage device 240, an Input/Output (I/O) interface 220, and a network interface 260.

The bus 210 interconnects the components of the computing device 200. The bus may be any circuitry suitable for interconnecting the components of the computing device 200.

For example, where the computing device 200 is a desktop or laptop computer, the bus 210 may be an internal bus located on a computer motherboard of the computing device. As another example, where the computing device 200 is a smartphone or tablet, the bus 210 may be a global bus of a system on a chip (SoC).

The processor 220 is a processing device configured to perform computer-executable instructions loaded from the memory 230. Prior to and/or during the performance of computer-executable instructions, the processor may load computer-executable instructions over the bus from the memory 230 into one or more caches and/or one or more registers of the processor. The processor 220 may be a central processing unit with a suitable computer architecture, e.g. an x86-64 or ARM architecture. The processor 220 may include or alternatively be specialized hardware adapted for application-specific operations.

The memory 230 is configured to store instructions and data for utilization by the processor 220. The memory 230 may be a non-transitory volatile memory device, such as a random access memory (RAM) device. In response to one or more operations by the processor, instructions and/or data may be loaded into the memory 230 from the persistent storage device 240 over the bus, in preparation for one or more operations by the processor utilising these instructions and/or data.

The persistent storage device 240 is a non-transitory non-volatile storage device, such as a flash memory, a solid state disk (SSD), or a hard disk drive (HDD). A non-volatile storage device maintains data stored on the storage device after power has been lost. The persistent storage device 240 may have a significantly greater access latency and lower bandwidth than the memory 230, e.g. it may take significantly longer to read and write data to/from the persistent storage device 240 than to/from the memory 230. However, the persistent storage 240 may have a significantly greater storage capacity than the memory 230.

The I/O interface 250 facilitates connections between the computing device and external peripherals. The I/O interface 250 may receive signals from a given external peripheral, e.g. a keyboard or mouse, convert them into a format intelligible by the processor 220 and relay them onto the bus for processing by the processor 220. The I/O interface 250 may also receive signals from the processor 220 and/or data from the memory 230, convert them into a format intelligible by a given external peripheral, e.g. a printer or display, and relay them to the given external peripheral.

The network interface 260 facilitates connections between the computing device and one or more other computing devices over a network. For example, the network interface 260 may be an Ethernet network interface, a Wi-Fi network interface, or a cellular network interface.

Implementations of the subject matter and the operations described in this specification can be realized in digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially-generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially-generated propagated signal. The computer storage medium can also be, or be included in, one or more separate physical components or media (e.g., multiple CDs, disks, or other storage devices).

While certain arrangements have been described, the arrangements have been presented by way of example only, and are not intended to limit the scope of protection. The inventive concepts described herein may be implemented in a variety of other forms. In addition, various omissions, substitutions and changes to the specific implementations described herein may be made without departing from the scope of protection defined in the following claims.

1. A computer-implemented method for determining summaries of text over multiple batches of text, the method comprising:
for each of a plurality of batches of text, each batch comprising text for addition to a cumulative document:
adding the batch of text to the cumulative document to produce an updated cumulative document;
encoding the updated cumulative document using an encoder neural network to obtain one or more encoder hidden states;
inputting the one or more encoder hidden states and a cumulative summary that summarises each preceding batch of text into a decoder neural network to generate a summary for the batch of text; and
updating the cumulative summary by adding the summary to the cumulative summary; and
outputting each summary.

2. The method of claim 1 wherein the batches are obtained separately over time and each summary is generated in response to the obtaining of the corresponding batch.

3. The method of claim 2 wherein, in response to each batch being obtained, the batch is immediately processed to determine a summary.

4. The method of claim 1 further comprising generating each batch by receiving a sequence of text and grouping the sequence of text into batches.

5. The method of claim 4 wherein each batch comprises:
a predetermined number of words;
a predetermined number of sentences;
a predetermined number of statements; or
a predetermined number of phrases.

6. The method of claim 4 wherein the sequence of text is a transcript of a conversation between multiple people and each batch relates to a predetermined number of turns in conversation.

7. The method of claim 1 wherein outputting each summary comprises one or more of:
outputting each summary separately;
outputting each cumulative summary separately; and
outputting each summary as part of a final cumulative summary comprising every summary for every batch of the plurality of batches.

8. The method of claim 1 wherein, for a first batch of the plurality of batches, inputting the one or more encoder hidden states and a cumulative summary that summarises each preceding batch of text into a decoder neural network comprises inputting the context vector and a start of sequence token.

9. The method of claim 1 wherein, for a first batch of the plurality of batches, adding the batch of text to the cumulative document to produce an updated cumulative document comprises setting the cumulative document to consist only of the first batch.

10. The method of claim 1 wherein each generated summary ends with an end of sequence token, and wherein the end of sequence token is removed from the cumulative summary before the cumulative summary is input into the decoder.

11. The method of claim 1 wherein each generated summary ends with an end of sequence token, and wherein the end of sequence token is removed from the cumulative summary before the cumulative summary is updated.

12. A system for determining summaries of text over multiple batches of text, the system comprising one or more processors configured to:
for each of a plurality of batches of text, each batch comprising text for addition to a cumulative document:
add the batch of text to the cumulative document to produce an updated cumulative document;
encode the updated cumulative document using an encoder neural network to obtain one or more encoder hidden states;
input the one or more encoder hidden states and a cumulative summary that summarises each preceding batch of text into a decoder neural network to generate a summary for the batch of text; and
update the cumulative summary by adding the summary to the cumulative summary; and
output each summary.

13. A non-transitory computer readable medium comprising computer executable instructions that, when executed by one or more processors, cause the one or more processors to perform a method comprising:
for each of a plurality of batches of text, each batch comprising text for addition to a cumulative document:
adding the batch of text to the cumulative document to produce an updated cumulative document;
encoding the updated cumulative document using an encoder neural network to obtain one or more encoder hidden states;
inputting the one or more encoder hidden states and a cumulative summary that summarises each preceding batch of text into a decoder neural network to generate a summary for the batch of text; and
updating the cumulative summary by adding the summary to the cumulative summary; and
outputting each summary.
